(19) United States
(12) Patent Application Publication
(10) Pub. No.: US 2009/0233805 A1
(43) Pub. Date: Sep. 17, 2009

(54) BIOCHIP AND IMMUNOLOGICAL ANALYSIS METHOD

(75) Inventors: Yoko Hayashi, Kyoto (JP); Osamu Takehiro, Aichi (JP)

Correspondence Address: GLOBAL IP COUNSELORS, LLP, 1233 20TH STREET, NW, SUITE 700, WASHINGTON, DC, 20036-2680, US

(73) Assignee: ROHM CO., LTD, Kyoto-shi, KYOTO (JP)

(21) Appl. No.: 12/065,028

(22) PCT Filed: Aug. 30, 2006
(86) PCT No.: PCT/JP2006/317044

§ 371 Date: Feb. 27, 2008

(30) Foreign Application Priority Data
Aug. 31, 2005 (JP) 2005-252105

(51) Int. Cl. C40B 30/04; C40B 60/12

(52) U.S. Cl. 506/9; 506/39

(57) ABSTRACT

The invention is intended to provide a biochip that allows analysis to be simplified by eliminating a washing step, that is small and inexpensive, and that permits fast, reliable analysis, as well as a method of immunological analysis using such a biochip. The present invention is a biochip comprising a mixing chamber for mixing analyte and labeled antibody reacting therewith, a reaction chamber including fixing means to which anti-idiotype antibody has been fixed, and a detection part for detecting the analyte, wherein the labeled antibody is contained in the mixing chamber or an adjacent part, the labeled antibody comprises an antibody component consisting of an F(ab′) fragment or reduced IgG and a label bound at a predetermined binding ratio, the reaction chamber and the detection part are separated by a channel part through which the fixing means is not allowed to pass, and the anti-idiotype antibody is an anti-idiotype antibody against the labeled antibody and is a type of antibody that cannot bind to the reaction product of the analyte and labeled antibody.

### TECHNICAL FIELD

The present invention relates to a biochip and an immunological analysis method employing the biochip.

### BACKGROUND ART

Biological materials such as DNA, enzymes, proteins, viruses, and cells have been conventionally analyzed by a variety of methods in the medical, food product, pharmaceutical and other fields, and a technique referred to as lab-on-chip has recently attracted attention as a means for simplifying such analysis.

This is a technique in which substances are mixed, reacted, separated, measured, detected, and the like on a substrate (biochip) of several centimeters referred to as a clinical analysis chip, environmental analysis chip, genetic analysis chip (DNA chip), protein analysis chip (proteome chip), sugar chain chip, chromatograph chip, cellular analysis chip, drug screening chip, or the like depending on the type of subject under analysis.

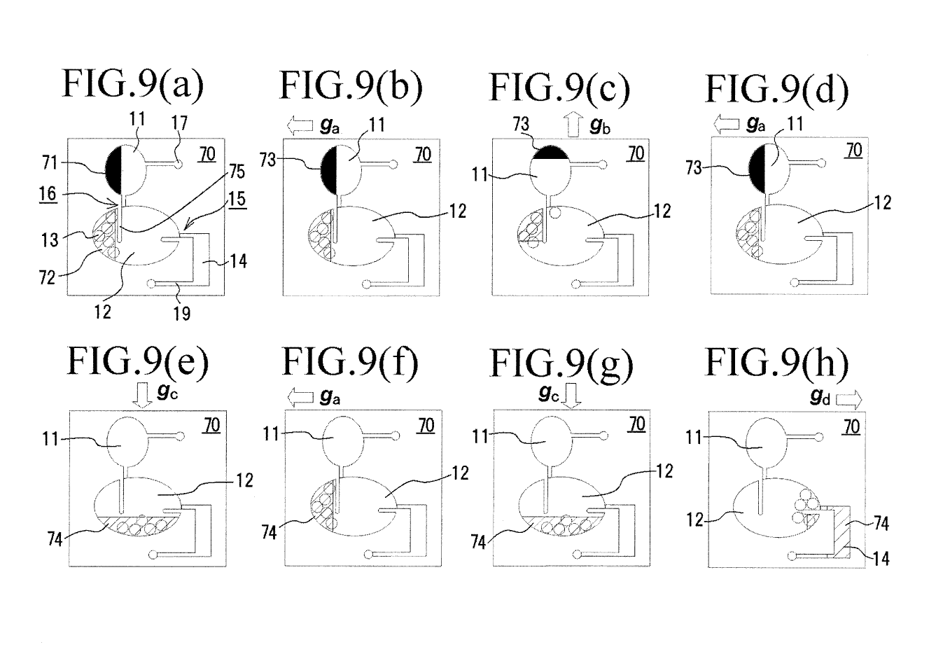

A method for immunological analysis by a variety of antigen-antibody reactions on such a microchip has been described in Japanese Unexamined Patent Application (Kokai) 2001-4628, for example. In the microchip 8 employed in this method, as illustrated in FIG. 9, solid microparticles 5 used as the solid phase in the reaction are loaded into a reaction chamber 6 having a vertical cross section area greater than the diameter of the particles. Joined to this reaction chamber 6 are a separator 7a having a vertical cross section area smaller than the diameter of the solid microparticles 5, and a waste liquid part 7a. Also connected to the reaction chamber 6 are injection parts 1, 2, 3, and 4 as well as introduction parts 1a, 2a, 3a, and 4a for injecting antigen, labeled antibody, antibody, washing liquid, and the like into the reaction chamber 6.

In this type of microchip 8, antigen and labeled antibody are sequentially introduced from the antigen injection part 1 and labeled antibody injection part 2 through the introduction parts 1a and 2a into the reaction chamber 6 to bring about a reaction. A washing liquid is introduced from the washing liquid injection part 4, and the unreacted material is separated using the separator 7a, so as to ultimately enable analysis by photothermal conversion analysis.

### SUMMARY OF THE INVENTION

### Problems which the Invention is Intended to Solve

However, as noted above, in this type of microchip 8, the solid microparticles 5 in the reaction chamber 6 must be washed at least once with washing solution before analysis to remove unreacted materials from around the solid microparticles. Two or more solutions containing antigen, labeled antibody, washing solution, and the like must also be separately introduced sequentially into the reaction chamber 6, making this a complicated process. Furthermore, heterogeneous reactions must be carried out two or more times, where antibody solution is reacted with and fixed to the solid microparticles, and a solution containing antigen or the like is mixed therewith to bring about a reaction, all of which is time-consuming. Additionally, in order to allow the multiple solutions to separately react in the reaction chamber, a plurality of injection parts and introduction parts are needed, as described above, taking up considerable area on the chip and making it impossible to produce a smaller, simpler microchip.

An object of the invention is to provide a biochip that allows analysis to be simplified by eliminating the washing step, that is small and inexpensive, and that permits fast, accurate quantitative analysis, as well as a method of immunological analysis using such a biochip.

### Means for Solving the Abovementioned Problems

The biochip of the present invention is a biochip having a mixing chamber for mixing analyte and labeled antibody reacting therewith, a reaction chamber including fixing means to which anti-idiotype antibody has been fixed, and a detection part for detecting the analyte, characterized in that the labeled antibody is contained in the mixing chamber or an adjacent part, the labeled antibody is composed of an antibody component consisting of an F(ab′) fragment or reduced IgG and a label bound at a predetermined binding ratio, the reaction chamber and detection part are separated by a channel part through which the fixing means is not allowed to pass, and the anti-idiotype antibody is an anti-idiotype antibody against the labeled antibody and is a type of antibody that cannot bind to the reaction product of the analyte and labeled antibody.

A mixing chamber is thus provided to allow the mixed and reacted analyte and labeled antibody to be brought into contact with the fixing means in the reaction chamber. Here, only what has not been captured by the anti-idiotype antibody fixed to the fixing means passes through the reaction chamber and is introduced into the detection part, and the unreacted label remains in the reaction chamber. The biochip can thus be used to omit the washing step after the reaction of the fixing means with the analyte and labeled antibody and the reaction between the analyte and labeled antibody, resulting in a simple and easy method of analysis. Furthermore, as there is no need to separately introduce multiple solutions into the reaction chamber, it is unnecessary to provide injection parts, introduction parts, or flow paths for separately introducing multiple solutions, so that less area on the biochip per se is used. Since there is no need for the analyte to bind to the fixing means, only the substance under analysis is introduced into the detection part for analysis, allowing the background to be minimized. This allows more precise analysis to be performed.

In the biochip of the present invention, the labeled antibody is preferably contained in an excess amount relative to the analyte, but the amount can be reduced as desired. The anti-idiotype antibody fixed to the fixing means is also preferably present in an excess amount relative to the labeled antibody. This will ensure that the analyte reacts with the labeled antibody, and that the remaining labeled antibody not reacting with the analyte will be removed by the fixing means, thus reducing measurement blanks and thereby lowering the lower detection limit as well as expanding the measurement range on the lower end of the concentration spectrum. The reduction in measurement blanks will also substantially expand the photometric range, thus expanding the measurement range at the higher end of the concentration spectrum. That is, higher precision analysis will be possible from lower to higher concentrations.

The fixing means can also be microparticles supporting the anti-idiotype antibody. This will ensure that the anti-idiotype antibody is easily fixed in the reaction chamber, and that the fixing means can trap the labeled antibody which is not bound to the analyte and which therefore is not to be measured. Here, labeled antibody that binds to the analyte will not be trapped.

The mixing chamber, reaction chamber, channel part, and detection part are also preferably connected in series, in that order. Such a structure will allow only the target of measurement to be separated and will enable a reaction for performing more accurate analysis without interference from other substances.

The labeled antibody may be held in advance in the mixing chamber. A holding chamber may also be provided in an adjacent part of the mixing chamber to hold the labeled antibody.

Reagents for detecting the label can be placed in the detection part. A substrate holding chamber may also be provided in an adjacent part of the detection part, such as between the channel part and detection part, and such reagents can be placed therein.

Reagents for detecting the label can thus be used to ensure more reliable quantification of the analyte bound to the labeled antibody and to allow the analyte to be analyzed with good precision. Analytes can be more accurately analyzed by common methods such as optical or electrochemical methods, particularly when an electron transport mediator or coloring substance, etc. is used as a substrate.

A pair of electrodes may also be formed in the detection part. In this way, an electrochemical method may be employed to analyze the analyte by a simple method such as the detection of current or voltage without the complications or the high cost and large scale equipment of conventional optical detection parts. The costs associated with analysis can therefore be reduced, and smaller biochips as well as smaller and less expensive analyzers can be used.

The immunological analysis method of the invention employs the biochip described above. That is, the method is characterized in that the analyte and the labeled antibody are mixed and reacted in the mixing chamber, the mixture/reaction product of the analyte and labeled antibody is introduced into the reaction chamber and are allowed to react with the fixing means to which anti-idiotype antibody has been fixed so as to capture the unreacted labeled antibody, the reaction product of the analyte and labeled antibody is separated and introduced into the detection part using the channel part, and the reaction product is analyzed by the detection part.

The analyte is preferably detected electrochemically or optically. This will allow a device based on detection methods conventionally used in the field to be employed. A simple, small, and inexpensive measuring device can particularly be used when analytes are electrochemically detected compared to when optically detected.

### EFFECT OF THE INVENTION

The present invention provides an immunological analysis method that allows analysis to be simplified by omitting the washing process, and allows accurate, rapid quantitative analysis. The simpler structure will also use up less area on chips, allowing smaller and less expensive biochips to be provided.

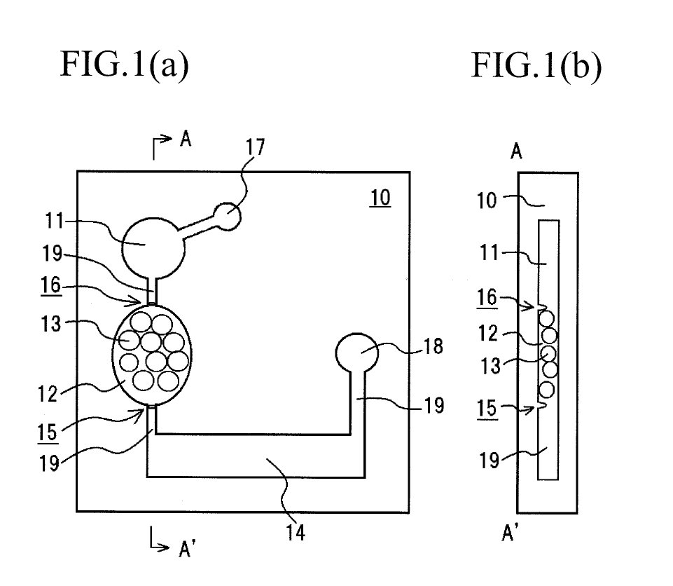

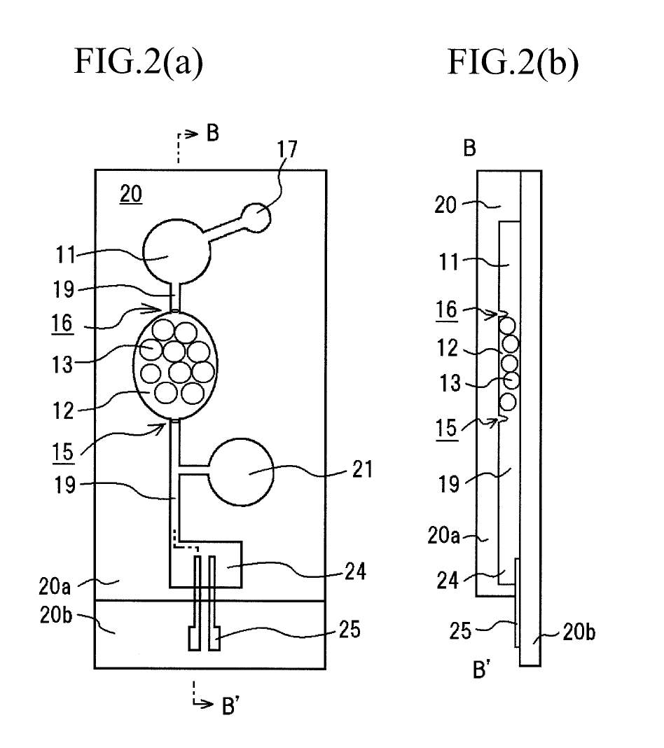

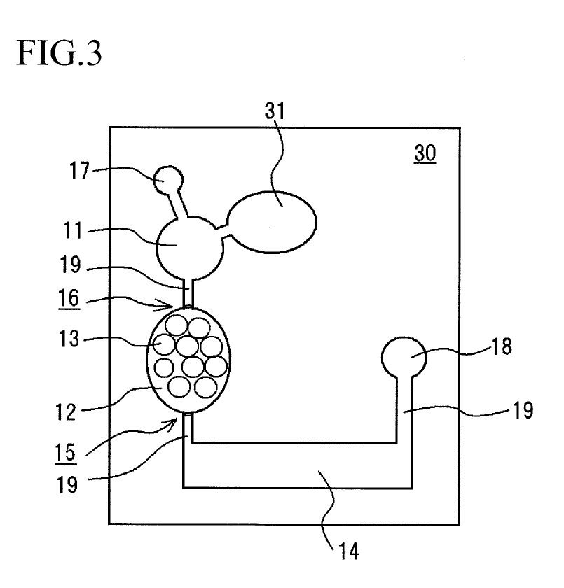

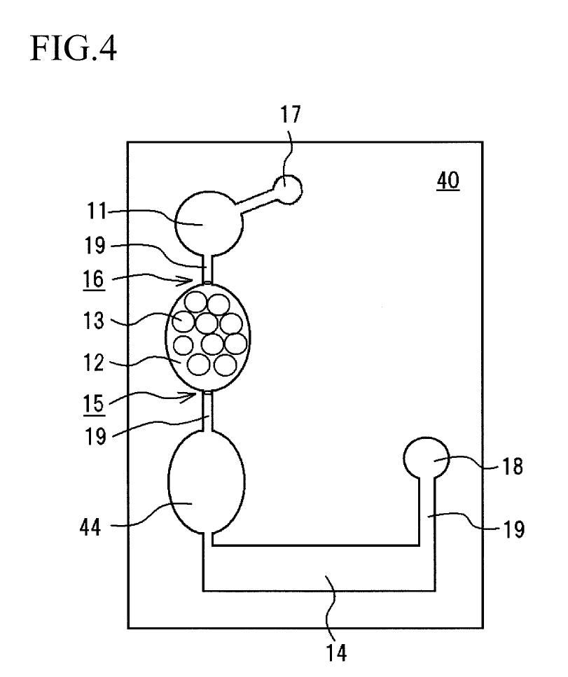

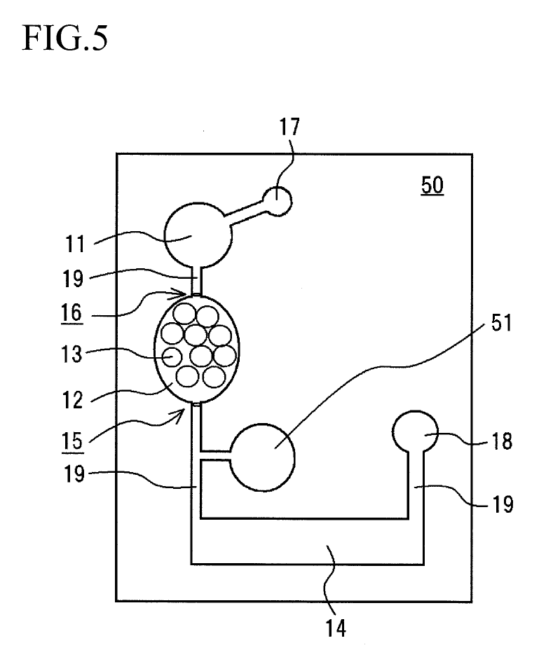

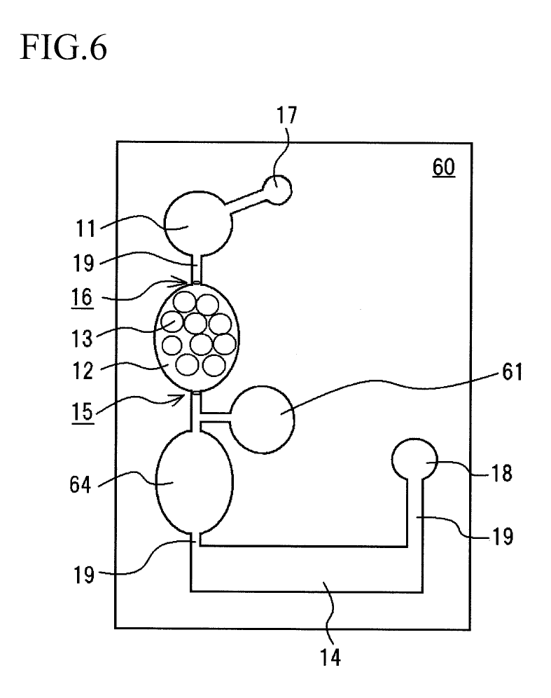

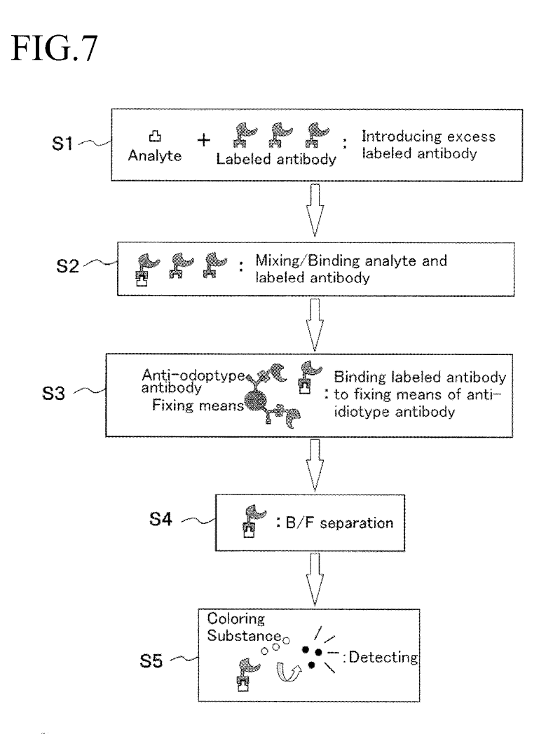

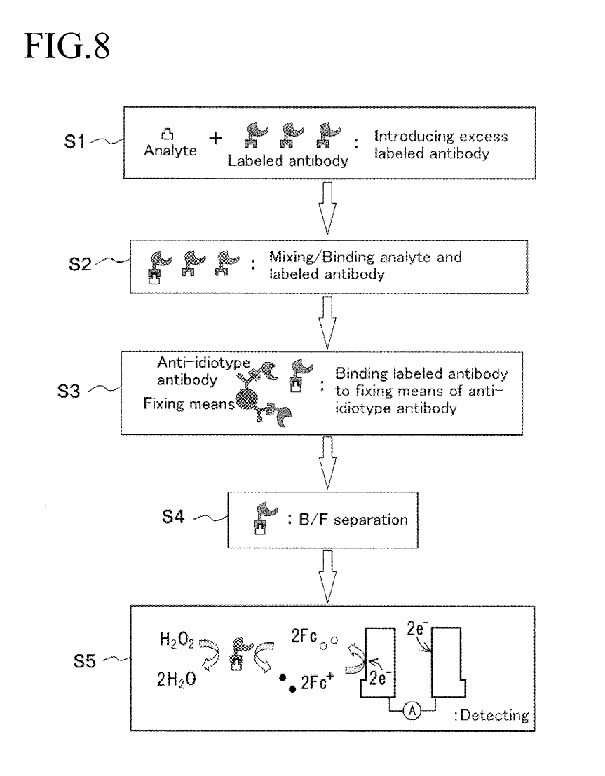

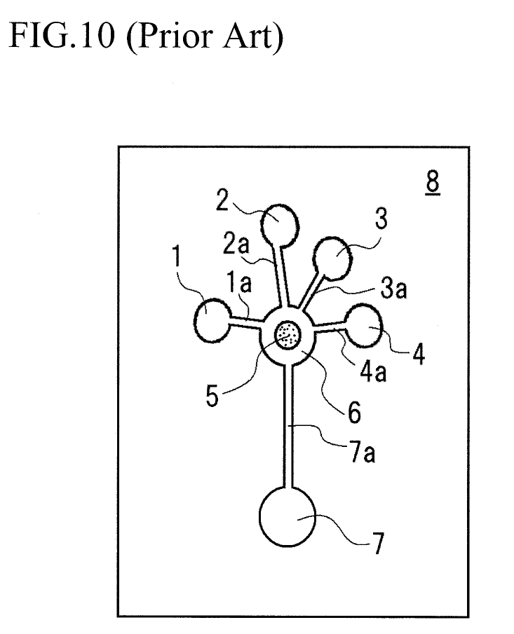

### BRIEF DESCRIPTION OF THE DRAWINGS

[FIG. 1] A plan and cross section of an embodiment of the biochip in the invention.

[FIG. 2] A plan and cross section of another embodiment of the biochip in the invention.

[FIG. 3] A plan of yet another embodiment of the biochip in the invention.

[FIG. 4] A plan of yet another embodiment of the biochip in the invention.

[FIG. 5] A plan of yet another embodiment of the biochip in the invention.

[FIG. 6] A plan of yet another embodiment of the biochip in the invention.

[FIG. 7] A flow cart for illustrating an immunological analysis method employing the biochip of the invention.

[FIG. 8] A flow cart for illustrating another immunological analysis method employing the biochip of the invention.

[FIG. 9] A plan process chart of a biochip for illustrating an immunological analysis method employing the biochip of the invention.

[FIG. 10] A plan of an embodiment of a conventional microchip.

### LEGENDS

10, 20, 30, 40, 50, 60, 70: biochip
11: mixing chamber
12: reaction chamber
13: fixing means
14, 24: detection part
15, 16: channel part
17: inlet
18: outlet
19: flow path
20a: upper base plate
20b: lower base plate
21, 61: substrate holding chamber
25: electrode
31: (labeled antibody) holding chamber
44, 51: dye holding chamber
64: mixing chamber
71: labeled antibody
72: buffer
73, 74: liquid mixture
75: protrusion

### BEST MODE FOR IMPLEMENTING THE INVENTION

The biochip of the present invention comprises at least a mixing chamber, reaction chamber, channel part, and detection part. These are preferably connected in series, in that order. A flow path may be formed in series between each of these elements, and other chambers or parts may be connected serially, additionally, or in tandem, with or without the flow path, to each of the structural elements.

The mixing chamber is a space for mixing the analyte and labeled antibody, and is defined as being a space separate from the reaction chamber and detection part described below. The size is not particularly limited. Although it must be big enough to realize the objectives, the size can be set as desired according to the type and amount of the substances, etc. The volume is about 10⁻² to 10³ mm³, for example. The shape of the mixing chamber is not limited, provided that it is suitable for the purpose of mixing. The planar and cross section configuration may be any shape, such as polygonal shapes, including tetragonal and trapezoidal shapes, as well as such shapes which are rounded at the corners, and round shapes, elliptical shapes, dome shapes, and irregular shapes that are asymmetrical on the left and right.

An inlet for externally injecting the analyte is preferably formed in the mixing chamber or an adjacent part, or connected to the mixing chamber or an adjacent part by a flow path. The shape, size, and the like of the flow path in such cases are not particularly limited. For example, the cross section area may be about 0.01 μm² to 100 mm², and the length may be about 1 μm to 100 mm.

The labeled antibody is preferably held in advance in the mixing chamber. A holding chamber may also be provided in an adjacent part of the mixing chamber to hold the labeled antibody. Such a holding chamber can also hold the analyte, and has the function of introducing the analyte or labeled antibody into the mixing chamber. The shape, size, and the like of the holding chamber can be the same as the mixing chamber.

The reaction chamber is defined as a space separate from the mixing chamber and detection part, and includes fixing means for fixing anti-idiotype antibody in the interior. As such, the reaction chamber must have enough space to hold the fixing means, and can be set as desired according to the type, amount, and the like of the fixing means. The volume is about 10⁻² to 10³ mm³, for example. The shape may be a variety of shapes the same as the mixing chamber.

The fixing means included in the reaction chamber is not particularly limited, provided that it can fix anti-idiotype antibodies, that is, antibodies that bind to unreacted antibodies by means of an antigen-antibody reaction, and will not affect the activity of anti-idiotype antibodies, etc. The shape, substance, amount, and the like can be adjusted as desired depending on the type of the analyte and labeled antibody, and the type of anti-idiotype antibody that is used. The fixing method can be any commonly used method such as physical adsorption, covalent bonding, ion bonding, cross linking, and electrostatic interaction. The fixing method will preferably not affect the activity of antigen, antibodies, and the like.

The fixing means can be housed in the reaction chamber, and includes those in the form of filters, woven materials, microparticles, and fibers, those in which the surface can expand such as foam and porous substances, and those generally used as supports for bioreactors, chromatography, and the like. Materials that can be used for microparticles, for example, include glass beads, polymer beads such as polystyrene, polymer compounds (gel) such as agarose, dextran, xanthan, and proteins in the form of microparticles, beads of silica, metal, or the like, and commercially available solid supports in the form of microparticles, etc. The diameter may be up to about 1 mm, about 10 μm to 1 mm, about 100 to 800 μm, about 200 to 600 μm, and about 200 μm to 1 mm.

A reaction chamber which has been formed so as to ensure the necessary surface area (that is, to increase the surface area) can be used along with, or instead of, the fixing means. Examples include roughening the surface of the walls that form the reaction chamber, and forming textures on the wall surface itself.

The mixing chamber and reaction chamber are preferably directly linked in series, with or without the flow path. In either case, a structure the same as or similar to the channel part described below is preferably included between the mixing chamber and reaction chamber so that the fixing means included in the reaction chamber will not migrate to the flow path and/or mixing chamber.

The channel part is formed between the reaction chamber and the detection part described below, and has a diameter smaller than the diameter of the fixing means present in the reaction chamber. Here, “diameter” can be the width, height, length, or the like, depending on the shape of the fixing means and/or channel part, but the “diameter” of the fixing means is suitably the maximum length (width) per fixing means unit, and the “diameter” of the channel part is suitably the minimum length (width) in the channel part cross section. That is, the function or shape may prevent the fixing means from passing into the reaction chamber outlet (and preferably inlet) in order for the channel part to ensure that the fixing means present in the reaction chamber stays only in the reaction chamber.

When the channel part is the flow path per se, it may be the flow path with a diameter narrower than the diameter of the fixing means, or one or more protrusions may be formed in part or parts of the flow path to narrow the diameter in the part or parts.

The detection part is a space for detecting the product that is produced from the analyte, label, or substrate, and is formed as a space separate from the mixing chamber and reaction chamber. The size and shape of the detection part are not particularly limited, and can be set as desired, for example, according to the detection method (procedure), type and amount of analyte, or the like. Specifically, the volume is about 1 to 10³ mm³. The shape can be a variety of shapes, the same as the mixing chamber.

When the detection method is an optical method, for example, the shape and size of the detection part must ensure a light path of a certain length so as to allow light to be directed onto the product produced from the analyte, label, or substrate, and the light to be sensed. When an electrochemical method is used, the detection part must be formed so that the charge of a solution containing the analyte can be sensed and so that a pair of electrodes based on a conductive material is in contact with the solution.

Here, the pair of electrodes can be any material of any size or shape that is ordinarily capable of functioning as an electrode. Examples include single layers, or laminates of two or more layers, of graphite, carbon, carbon black, or the like; metals such as gold, platinum, silver, copper, and aluminum, or alloys thereof, or conductive oxides or the like, such as SnO₂, In₂O₃, WO₃, and TiO₂. The electrodes may be formed by applying pieces of conductive material to the biochip, embedding portions, or employing a printing technique such as screen printing using a conductor paste.

The detection part is preferably directly linked in series, with or without the flow path, to the reaction chamber. In either case, it is suitable for the channel part to be formed between the detection part and reaction chamber so that the fixing means included in the reaction chamber will not migrate to the flow path and/or detection part, both being separate.

A substrate holding chamber for holding substrate or the like may be connected serially or additionally, with or without the flow path, between adjacent parts of the detection part, such as the channel part and detection part. The substrate holding chamber can be the same shape, size, and the like as the mixing chamber or the like, for example. This will allow the substrate or the like to be held in advance or directly before use in the substrate holding chamber, allowing the analyte to be sensed more reliably and/or more simply by the detection part.

Here, the substrate or the like can be a commonly used reagent for detecting labels. Examples include dyes, pigments, fluorescent substances, or the like, organic or inorganic acids, or electron transport mediators capable of functioning as electron transport media allowing electrons to be exchanged between the analyte and electrode, either individually or in combinations of two or more.

Examples of dyes, pigments, and fluorescent substances include OPD (ortho-phenylenediamine), TMBZ (3,3′,5,5′-tetramethylbenzidine), Tyramin, Luminol, luciferin and the like. Examples of organic and inorganic acids include hydrogen peroxide, formic acid, acetic acid and the like.

Examples of electron transfer mediators include ferrocene, alkali metal ferricyanides (such as potassium ferricyanide, lithium ferricyanide, and sodium ferricyanide) or alkyl substitutes thereof (such as methyl, ethyl, and propyl substitutes), Methylene Blue, phenazine methosulfate, p-benzoquinone, 2,6-dichlorophenol-indophenol, potassium β-naphthoquinone-4-sulfonate, phenazine ethosulfate, viologens, Vitamin K, and other redox compounds, either individually or in combinations of two or more. Of these, ferrocene, potassium ferricyanide, and the like are preferred.

Methods for retaining such substrates can utilize any suitable well-known method in the art, such as methods in which the substrate as such is dissolved or suspended in a solvent or the like that will not inhibit the substrate function, and is applied and dried, and methods in which the substrate is mixed with or dispersed in a suitable support (such as the fixing means noted above) and fixed.

The biochip described above can be formed with the same materials as the conventional chips referred to by the various names noted above. Examples include organic compounds such as PET (polyethylene terephthalate), PDMS (polydimethyl siloxane), PMMA (polymethyl methacrylate), PC (polycarbonate), PP (polypropylene), PS (polystyrene), PVC (polyvinyl chloride), polyethylene, polysiloxane, allyl ester resins, cycloolefin polymer and the like, and inorganic compounds such as Zeonor, silicon, quartz, glass, ceramic and the like.

The biochip of the present invention can be readily produced, primarily by laminating first and second base plates having patterns in a variety of shapes based on indentations in one or two sides, for example, by means of welding, adhesives, ultrasonic treatment, or the like. Specifically, a mold having a shape corresponding to the desired reaction chamber or the like is prepared. The mold can be formed by mechanical machining. A resin is then molded or the like in the mold, giving a base plate onto which the shape of the reaction chamber or the like has been transferred. Finally, two base plates are laminated so that the patterns correspond to each other. A base plate with a pattern corresponding to the mixing chamber or the like may be on one side, and the other may be a flat base plate. Injection molding, imprinting, or the like may also be used instead of molding with a mold. One or both sides of a flat base plate may directly subjected to a photolithography process, mechanical machining, or the like, giving a base plate on which a pattern corresponding to the mixing chamber or the like has been transferred.

The biochip of the invention may be handled (such as sample introduction, mixing, stirring, sample transfer, detecting, etc.) manually, automatically, or semi-automatically. For example, stirring and mixing, sample transfer or the like can be done by methods using a pump or methods making use of vibrations or centrifugal force.

In the immunological analysis method of the present invention, the analyte and labeled antibody are first mixed and reacted in the mixing chamber. The molecular weight or the like of the analyte that is mixed in the mixing chamber is not particularly at issue, provided that antibody against the analyte is available. Examples include bacteria, viruses, parasites, proteins, peptides, DNA, drugs and the like.

A label for detecting an analyte is bound to the labeled antibody. Examples of labels include any commonly used in the art, such as enzymes, dyes, redox substances, fluorescent substances, radioactive substances, metal particles, magnetic elements and the like. The antibody component consists of a F(ab′) fragment or reducing IgG, which is bound with the label at a specific binding ratio such as 1:1 to 1:n (where n is an integer, preferably 1 to 5) described below. The label and antibody are suitably bound in advance by means of a method commonly used in the art (binding by antigen-antibody reaction).

It is considered that examples of methods for mixing and reacting the analyte and labeled antibody in the mixing chamber include a variety of methods such as methods in which sample containing the analyte is introduced into the mixing chamber while mixed with the labeled antibody held in a holding layer, and methods in which sample containing the analyte is introduced into the mixing chamber and mixed with labeled antibody already being held in the mixing chamber. At this time, the labeled antibody is preferably reacted in an excess amount relative to the amount of analyte. This will allow all of the analyte to be labeled. Here, because the amount of the analyte per se will normally be unknown, the measurable analyte concentration or range can be set beforehand using a biochip, for example, and an amount 1 to 100 times (molar ratio) the upper limit of the set concentration or range may suitably be introduced as the excess amount in order to introduce an excess amount of labeled antibody.

The mixing and reaction conditions are not particularly limited and can be set as desired based on the type of labeled antibody or analyte being measured, but conditions that will not affect the activity of the substances such as about 30 seconds to 10 minutes at a temperature of about 20 to 40° C. may be contemplated.

The mixture/reaction product of the analyte and labeled antibody is then introduced into the reaction chamber. Here, as noted above, since an excess amount of labeled antibody was introduced into the mixing chamber, the remaining labeled antibody and the reaction product of the labeled antibody and analyte are usually introduced into the reaction chamber. The labeled antibody and reaction product that have thus been introduced into the reaction chamber come into contact with the anti-idiotype antibody fixed to the fixing means and thereby pass through the reaction chamber either bound or unbound to the anti-idiotype antibody as a result of an antigen-antibody reaction.

The anti-idiotype antibody in the present invention is antibody that recognizes the inherent structure of the antigen binding site of the antibody component of the labeled antibody. It is known that there are types of anti-idiotype antibody in which antigen (analyte) does or does not inhibit binding to the target antibody (antibody component of the labeled antibody), but the anti-idiotype antibody in the present invention indicates a type in which binding is inhibited by antigen (analyte), that is, a type which cannot bind to a binding substance of the antigen (analyte) and labeled antibody.

The anti-idiotype antibody can be readily produced in the usual manner. For example, when preparing an anti-idiotype antibody of mouse monoclonal antibody, if the monoclonal antibody serving as the antigen can be administered in the form of a KLH conjugate to mice, it can then be prepared in accordance with the usual methods for producing monoclonal antibody. The anti-idiotype antibody can therefore be readily mass produced in the same manner as ordinary monoclonal antibodies.

As such, when the mixture/reaction product (reaction solution) of the analyte and labeled antibody passes through the reaction chamber, the unreacted labeled antibody is trapped by the anti-idiotype antibody fixed to the fixing means and cannot pass from the reaction chamber into the detection part, whereas the analyte bound to the labeled antibody is not trapped by the fixing means and can thus be extracted through the channel part into the detection part. Enough anti-idiotype antibody should be fixed to the fixing means in order to trap the unreacted labeled antibody. That is, an excess amount is preferably used. This type of treatment in the reaction chamber allows what is referred to as B/F separation, where the unused labeled antibody is controlled enough so as not to affect the precision of the measured results, and substantially all of the analyte in the sample is separated while labeled so it can be measured.

The reaction product is then analyzed by the detection part. The analysis here can be done by any well-known method in the art for quantifying the analyte, such as optical methods for measuring the coloring intensity of a dye, electrochemical methods for measuring current or voltage based on electron exchange, electrical methods, radioimmunoassay for measuring the intensity of radioisotopes, and methods based on magnetism (such as the use of magnetic beads as the label).

### EXAMPLE 1

As illustrated in FIGS. 1(a) and (b), the biochip 10 of the present invention is composed by arranging a mixing chamber 11, reaction chamber 12, channel part 15, and detection part 14 in series.

The mixing chamber 11 is a chamber in which analyte and labeled antibody are mixed. Here, for example, C-reactive protein (CRP) as the analyte and horse radish peroxidase (HRP)-labeled anti-CRP antibody as the labeled antibody are mixed. The mixing chamber 11 has a space, for example, of about 50 mm² (plane area)×1 mm (depth). The labeled antibody is prepared, for example, using a common cross linker.

The reaction chamber 12 has a space, for example, of about 50 mm² (plane area)×1 mm (depth), which contains the fixing means 13 for fixing the anti-idiotype antibody. As the fixing means 13, spherical Chitopearl (by Fujibo) about 0.4 mm in diameter, for example, may be introduced so as to occupy about 70% of the reaction chamber 12. Anti-idiotype antibody against the anti-CRP antibody is fixed to the fixing means 13 as a substance capable of binding to the labeled antibody by means of antigen-antibody reaction.

The channel part 15 is formed with a width of about 100 μm, a depth of about 0.2 mm, and a diameter smaller than the diameter of the Chitopearl, which is the fixing means 13 in the reaction chamber 12, so that the Chitopearl will not move from the reaction chamber 12 to other locations. In order to measure the absorbance as the optical detection, for example, the detection part 14 has a constant shape of about 100 mm in length and a cross section area of about 1 mm². An injection inlet 17 for injecting samples containing analyte is connected to the mixing chamber 11.

A flow path 19 is connected between the mixing chamber 11 and reaction chamber 12, and the reaction chamber 12 (channel part 15) and detection part 14, respectively, and a channel part 16 having a diameter smaller than the diameter of the fixing means 13 is formed in the flow path 19 near a inlet of the reaction chamber 12. Also, an outlet 18 is connected to the detection part 14 via the flow path 19.

In a biochip 10 of this type of structure, for example, 3 μl sample containing analyte and an excess amount of labeled antibody relative to the analyte (molar ratio of about 1 to 100 times the concentration of analyte set in advance using the biochip) are first introduced through the sample injection inlet 17 in S1 of FIG. 7. In S2, the introduced sample is transferred to and mixed in the mixing chamber 11, the analyte and labeled antibody react, in this case substantially all of the analyte binds to the labeled antibody, and some of the labeled antibody does not bind to the analyte and is left over.

In S3, the reaction product and the like is transferred to the reaction chamber 12 through the resulting centrifugal force or pressure, etc., which is obtained by rotating the biochip 10, and the labeled antibody binds to the antibody of the fixing means 13 in the reaction chamber 12. Here, the antibody of the fixing means 13 reacts with the anti-CRP antibody of the labeled antibody in competition with the CRP that is the analyte. As such, only the labeled antibody that has not been bound to the analyte binds to the antibody of the fixing means 13. The method for fixing the antibody to the fixing means 13 was based on the method recommended by the supplier. Thus, as shown in S4, the labeled antibody bound to the fixing means 13 is trapped in the reaction chamber 12 by the channel part 15, and only the analyte bound to the labeled antibody can move to the detection part without binding to the fixing means 13, what is referred to as B/F separation.

Then, as shown in S5, the analyte bound to the labeled antibody which has been introduced into the detection part causes the dye which has already been introduced into the detection part (SAT-Blue (Dojindo Laboratories)) to become colored as a result of the activity of the HRP in the labeled antibody. The change in the absorbance of the sample at 670 nm, for example, can be measured to quantify the analyte in the sample. All the operations can be done at room temperature.

### EXAMPLE 2

The biochip in this example has the substantially the same structure as the biochip in FIG. 1 except that, as illustrated in FIGS. 2(a) and (b), a pair of carbon black-based electrodes 25 is formed in the detection part 24, and a substrate holding chamber 21 is formed via a flow path 19 between the channel part 15 and the detection part 24.

The electrodes 25 are formed, for example, with a carbon paste to a length of about 10 mm and a thickness of about 15 μm. The electrodes 25 are located in positions corresponding to the detection part 24 in the lower base plate 20b forming the biochip 20, and the upper base plate 20a is laminated onto the lower base plate 20b in such a way that part of the electrodes 25 is covered and part is exposed, with the detection part 24 sealed off and the electrodes protruding out from inside the detection part 24.

A substrate holding chamber 21 is also formed with substantially the same size and shape as the mixing chamber 11, and 3 mM ferrocene and 5 mM hydrogen peroxide as the substrate are held in advance or immediately before use. The substrate is held, for example, by introducing a certain amount of hydrogen peroxide and ferrocene (Fc) in the form of an aqueous solution into the substrate holding chamber.

In the biochip 20 having this structure, the sample and labeled antibody are introduced, in S1 of FIG. 8, through the injection inlet 17 in the same manner as in Example 1, and are mixed and reacted in S2. Then, in S3, the labeled antibody is allowed to bind to the antibody of the fixing means 13 in the same manner as in Example 1, followed by B/F separation in S4.

Then, as shown in S5, the ferrocene added as substrate is converted to ferricinium ion (Fc⁺) by the enzyme (label) and further undergoes redox, where it is reduced on the electrodes, so as to measure the current produced at that time. The current is a value proportionate to the amount of analyte, that is, the concentration of the reaction of the analyte and labeled antibody, allowing the analyte to be quantitatively measured. The electrode potential is 0 V, and a reference electrode may be used (such as Ag/AgCl).

### EXAMPLE 3

As illustrated in FIG. 3, the biochip 30 in this example has substantially the same structure as the biochip in FIG. 1 except that a labeled antibody holding chamber 31 is formed via the flow path 19 to the mixing chamber 11.

The labeled antibody is introduced in advance or immediately before use into the labeled antibody holding chamber 31 and is introduced into the mixing chamber 11 at the same time that the sample is introduced through the injection inlet 17, and the labeled antibody and sample (analyte) are mixed and reacted in the mixing chamber 11.

This type of biochip 30 can perform immunological analysis by means of the steps in FIG. 7 as described in Example 1 when the analyte is anti-CRP antibody, the labeled antibody is horse radish peroxidase (HRP)-labeled CRP, and the antibody fixed to the fixing means is anti-CRP antibody.

### EXAMPLE 4

As illustrated in FIG. 4, the biochip 40 in this example has substantially the same structure as the biochip in FIG. 1 except that a substrate holding chamber 44 is formed in series between the channel part 15 and detection part 14.

A dye, for example, is held in the substrate holding chamber 44 in advance or immediately before use, and analyte which is undergone so-called B/F separation from the reaction chamber 12 is mixed with the dye and introduced into the detection part 14.

This type of biochip 40 can perform immunological analysis by means of the steps in FIG. 7 as described in Example 1.

### EXAMPLE 5

As illustrated in FIG. 5, the biochip 50 in this example has substantially the same structure as the biochip in FIG. 4 except that a substrate holding chamber 51 is additionally formed via a flow path between the channel part 15 and detection part 14.

A dye, for example, is held in the substrate holding chamber 51 in advance or immediately before use, and the dye is injected during so-called B/F separation from the reaction chamber 12 and is introduced into the detection part 14.

This type of biochip 50 can perform immunological analysis by means of the steps in FIG. 7 as described in Example 1.

### EXAMPLE 6

As illustrated in FIG. 6, the biochip 60 in this example has substantially the same structure as the biochip in FIG. 4 except that a substrate holding chamber 51 is additionally formed via a flow path between the channel part 15 and detection part 14, and a mixing chamber 64 is formed in series between the detection part 14 and a connector to the substrate holding chamber 51.

A dye, for example, is held in the substrate holding chamber 61 in advance or immediately before use, the dye is injected at the same time as so-called B/F separation from reaction chamber 12, the dye is mixed with the analyte bound to the labeled antibody in the mixing chamber 64, and they are introduced into the detection part 14.

This type of biochip 60 can perform immunological analysis by means of the steps in FIG. 7 as described in Example 1.

### EXAMPLE 7

As illustrated in FIG. 9(a), the biochip 70 in this example has substantially the same structure as the biochip 10 in FIG. 1 except that a protrusion 75 for controlling the excess migration of the fixing means 13 is formed near the channel parts 16 and 15 of the inlet and outlet of the reaction chamber 12.

In this biochip 70, as illustrated in FIG. 9(a), for example, the labeled antibody 71 is introduced in advance into the mixing chamber, and the fixing means 13 supporting the anti-idiotype antibody against the antibody component forming the labeled antibody 71 is held in the reaction chamber 12 while impregnated with buffer 72.

The sample containing the analyte is first introduced through the sample injection inlet 17, and centrifugal force is then applied in the direction of the arrow indicated by ga to the biochip as illustrated in FIG. 9(b), giving a mixture 73 containing the mixture/reaction product of the sample and labeled antibody 71.

Then, as shown in FIGS. 9(c) and (d), centrifugal force is applied in the directions gb and ga, in that order, to thoroughly mix the mixture 73. Then, as shown in FIG. 9(e), centrifugal force is applied in the direction gc on the biochip 70, and the mixture 73 is introduced into the reaction chamber 12, giving a mixture 74 of buffer and mixture 73.

Next, as illustrated in FIGS. 9(g) and (g), centrifugal force is applied in directions ga an gc, in that order, to thoroughly mix the mixture 74, and the mixture 74 is mixed with the fixing means 13. In this way, only the labeled antibody contained in the mixture 74 reacts with the anti-idiotype antibody of the fixing means 13 and is trapped by the fixing means.

After that, as shown in FIG. 9(h), centrifugal force is applied in the direction gd on the biochip 70. As a result of this, the labeled antibody bound to the fixing means 13 is kept in the reaction chamber 12 by the channel part 15, and only the analyte bound to the labeled antibody can move into the detection part 14 without being bound to the fixing means 13, for so-called B/F separation to take place. The analyte in the sample is then quantified in the same way as in S5 in FIG. 7.

At this time, all of the mixture 74 may be introduced into the detection part 14, but a portion of the mixture 74 is preferably left in the reaction chamber 12, as illustrated in FIG. 9(h). This is done in order to prevent measurement errors which may result when the buffer contained in the individual fixing means 13 (such as deep layer liquid contained in the beads) is completely removed and introduced into the detection part.

1. A biochip comprising
a mixing chamber for mixing analyte and labeled antibody reacting therewith,
a reaction chamber including fixing means to which anti-idiotype antibody has been fixed, and
a detection part for detecting the analyte,
wherein the labeled antibody is contained in the mixing chamber or an adjacent part, the labeled antibody comprises an antibody component consisting of an F(ab′) fragment or reduced IgG and a label bound at a predetermined binding ratio,
the reaction chamber and the detection part are separated by a channel part through which the fixing means is not allowed to pass, and
the anti-idiotype antibody is an anti-idiotype antibody against the labeled antibody and is a type of antibody that cannot bind to the reaction product of the analyte and labeled antibody.

2. The biochip according to claim 1, wherein the labeled antibody is included in an excess amount relative to the analyte.

3. The biochip according to claim 1, wherein the anti-idiotype antibody is fixed in an excess amount relative to the analyte.

4. The biochip according to claim 1, wherein the fixing means is microparticles.

5. The biochip according to claim 1, wherein the mixing chamber, reaction chamber, channel part, and detection part are connected in series in that order.

6. The biochip according to claim 1, further comprising a holding chamber for holding the labeled antibody, which is connected to an adjacent part of the mixing chamber.

7. The biochip according to claim 1, further comprising a substrate holding chamber for holding a reagent for detecting labeled antibody, which is connected to an adjacent part of the detection part.

8. The biochip according to claim 7, further comprising an electron transport mediator or coloring substance held in the substrate holding chamber.

9. The biochip according to claim 1, further comprising a pair of electrodes formed in the detection part.

10. An immunological analysis method employing a biochip comprising a mixing chamber for mixing analyte and labeled antibody reacting therewith, a reaction chamber including fixing means to which anti-idiotype antibody has been fixed, and a detection part for detecting the analyte, wherein the reaction chamber and detection part are separated by a channel part through which the fixing means is not allowed to pass, and the anti-idiotype antibody is an anti-idiotype antibody against the labeled antibody and is a type of antibody that cannot bind to the reaction product of the analyte and labeled antibody, the immunological analysis method comprising the step of
reacting the analyte and the labeled antibody by mixing in the mixing chamber, using the labeled antibody comprising an antibody component consisting of an F(ab′) fragment or reduced IgG and a label bound at a predetermined binding ratio,
introducing the mixture/reaction product of the analyte and labeled antibody into the reaction chamber and, reacting it with the fixing means to which anti-idiotype antibody has been fixed to capture the unreacted labeled antibody,
introducing the reaction product of the analyte and the labeled antibody into the detection part using the channel part, and
detecting the analyte through the analysis of the reaction produced by the detection part.

11. The immunological analysis method according to claim 10, wherein the labeled antibody is added in an excess amount relative to the analyte and mixed.

12. The immunological analysis method according to claim 10, wherein the anti-idiotype antibody is used in an excess amount relative to the labeled antibody.

13. The immunological analysis method according to claim 10, wherein the analyte is detected electrochemically or optically.
